(19) United States
(12) Patent Application Publication
(10) Pub. No.: US 2014/0271369 A1
(43) Pub. Date: Sep. 18, 2014

(54) System and Method for Processing Both Clinical Chemistry and Immunoassay Tests

(71) Applicant: ABBOTT LABORATORIES, ABBOTT PARK, IL (US)

(72) Inventor: Patrick P. Fritchie, Southlake, TX (US)

(21) Appl. No.: 14/214,210

(22) Filed: Mar. 14, 2014

Related U.S. Application Data
(60) Provisional application No. 61/793,744, filed on Mar. 15, 2013.

(51) Int. Cl. G01N 35/00

(52) U.S. Cl. CPC G01N 35/00584
USPC 422/82.09; 422/68.1; 422/82.08

(57) ABSTRACT

Disclosed herein are instruments, systems and methods for performing automated integrated analysis of both clinical chemistry assay and immunoassay tests on a sample. The system includes a common process subsystem module; a clinical chemistry analyzer module; an immunoassay analyzer module; and a plurality of additional modules. The common process subsystem module is configured to position one or more reaction vessels containing aliquots of the sample for analysis by the clinical chemistry analyzer module, the immunochemistry analyzer module or both analyzer modules. The included immunochemistry analyzer module of the instrument and system is configured to perform multiplex FRET analysis on homogeneous solutions, thereby increasing the flexibility, throughput and robustness of the resultant instrument and systems.

### CROSS-REFERENCE TO RELATED APPLICATIONS

This application claims benefit of priority to U.S. provisional application No. 61/793,744, filed on Mar. 15, 2013, which is incorporated by reference in its entirety.

### BACKGROUND OF THE INVENTION

1. Field of the Invention

This invention is directed to an automated clinical analyzer systems and methods for processing and testing samples for both clinical chemistry assay and immunoassay.

2. Discussion of the Art

Automated analyzers are well-known in the field of clinical chemistry and in the field of immunochemistry. Analyzers are typically configured to perform analysis for a collection of samples according to specific assay platforms unique to the particular clinical chemistry or immunochemistry involved. The instruments implement usually one set of assays for a given clinical chemistry assay or immunochemistry assay, as will be briefly described below.

Clinical chemistry is the area of pathology that is generally concerned with analysis of body fluids. The discipline originated in the late nineteenth century with the use of simple chemical tests for various components of blood and urine. Subsequently other techniques were applied including the use and measurement of enzyme activities, spectrophotometry, electrophoresis, and immunoassay. Most current laboratories are not highly automated and use assays that are monitored closely and controlled for quality. Clinical chemistry tests can be performed on any kind of body fluid, but are generally performed on serum or plasma.

An immunoassay is a biochemical test that measures the presence or concentration of a substance in solutions that frequently contain a complex mixture of substances. Analytes in biological liquids such as serum or urine are frequently assayed using immunoassay methods. Such assays are based on the unique ability of an antibody to bind with high specificity to one or a very limited group of molecules. A molecule that binds to an antibody is called an antigen. Immunoassays can be carried out for either member of an antigen/antibody pair. For antigen analytes, an antibody that specifically binds to that antigen can frequently be prepared for use as an analytical reagent. When the analyte is a specific antibody, its cognate antigen can be used as the analytical reagent. In either case the specificity of the assay depends on the degree to which the analytical reagent is able to bind to its specific binding partner to the exclusion of all other substances that might be present in the sample to be analyzed. In addition to the need for specificity, a binding partner must be selected that has a sufficiently high affinity for the analyte to permit an accurate measurement. The affinity requirements depend on the particular assay format that is used.

In addition to binding specificity, an immunoassay provides a means for producing a measurable signal in response to a specific binding. Historically, the signal involved measuring a change in some physical characteristic such as light scattering or changes in refractive index. Most immunoassays today depend on the use of an analytical reagent that is associated with a detectable label. A large variety of labels have been demonstrated including radioactive elements used in radioimmunoassay; enzymes; fluorescent, phosphorescent, and chemiluminescent dyes; latex and magnetic particles; dye crystallites, gold, silver, and selenium colloidal particles; metal chelates; coenzymes; electroactive groups; oligonucleotides, stable radicals and others. Such labels serve for detection and quantitation of binding events either after separating free and bound labeled reagents or by designing the system in such a way that a binding event effects a change in the signal produced by the label. Immunoassays requiring a separation step, often called separation immunoassays or heterogeneous immunoassays, are popular because they are easy to design, but they frequently require multiple steps including careful washing of a surface onto which the labeled reagent has bound. Immunoassays in which the signal is affected by binding can often be run without a separation step. Such assays can frequently be carried out simply by mixing the reagents and sample and making a physical measurement. Such assays are called homogeneous immunoassays or less frequently non-separation immunoassays.

Regardless of the method used, interpretation of the signal produced in the immunoassay requires reference to a calibrator that mimics the characteristics of the sample medium. For qualitative assays the calibrators may consist of a negative sample with no analyte and a positive sample having the lowest concentration of the analyte that is considered detectable. Quantitative assays require additional calibrators with known analyte concentrations. Comparison of the assay response of a real sample to the assay responses produced by the calibrators makes it possible to interpret the signal strength in terms of the presence or concentration of analyte in the sample.

Automated analyzers for clinical chemistry that are commercially available include those sold under the trademarks ARCHITECT c16000, ARCHITECT c4000, and ARCHITECT c8000, all of which are commercially available from Abbott Laboratories (Abbott Park, Ill. (US)). Automated analyzers for immunoassays that are commercially available include those sold under the trademarks ARCHITECT i1000SR, ARCHITECT i2000SR, ARCHITECT i4000SR, and AxSYM, all of which are commercially available from Abbott Laboratories (Abbott Park, Ill. (US)). Analytical instruments for performing clinical chemistry assays or immunochemistry assays are also commercially available from other suppliers, such as Roche Diagnostics, Siemens AG, Dade Behring Inc., Beckman Coulter Inc. and Ortho-Clinical Diagnostics.

The analyzers from various commercial suppliers suffer from various shortcomings. Some automated analyzers are not capable of being modified to suit the demands of certain users. For example, even if a user desires to have more immunoassay reagents on an analyzer and fewer clinical chemistry reagents on the analyzer, or vice versa, the user cannot modify the configuration. Furthermore, the addition of additional immunoassay modules and/or clinical chemistry modules to increase throughput is difficult, if not impossible. Some automated analyzers require a great deal of maintenance, both scheduled and unscheduled. In addition, some automated analyzers have scheduling protocols for assays that cannot be varied, for example, the assay scheduling protocols are fixed, which limits features such as throughput. Modification of current assay protocols or addition of new assay protocols can be difficult, if not impossible. Some of analyzers occupy a great deal of floor space and consume large quantities of energy.

Thus, there is a need for automated analyzers to incorporate greater automation of processes on the fly, such as improved integration of clinical chemistry assays with immunoassays, common means of reagent storage, loading and mixing of reagents and other components with the test sample in reaction vessels, and automated removal of waste from the reaction vessels. Such improvements in the instrumentation might lead to increased efficiencies, reduced costs for equipment and supplies, and more reliable equipment.

### SUMMARY OF THE INVENTION

Disclosed herein as a first aspect is an instrument for performing automated integrated analysis of both clinical chemistry assay and immunoassay tests on a sample. The system includes several modules such as a common process subsystem module; a clinical chemistry analyzer module; an immunoassay analyzer module; and a plurality of additional modules. The common process subsystem module is configured to position one or more reaction vessels containing aliquots of the sample for analysis by the clinical chemistry analyzer module, the immunochemistry analyzer module or both analyzer modules.

In a second aspect, an immunoassay analyzer module for integration into an clinical chemistry analyzer instrument is described. The immunoassay analyzer module includes a light source; a multiplex light generator; a multiplex light reader; and a detector system.

In a third aspect, a system for performing automated analytic analysis of clinical chemistry assay and immunoassay tests on a sample is described. The system includes a common process subsystem module; a clinical chemistry analyzer module; an immunoassay analyzer module; a plurality of additional modules comprising a sample dispensing module, one or more reagent modules, a mixing module and a washing station module; a control architecture; and a user interface. The common process subsystem module includes an assembly having a carousel with a plurality of reaction vessel holders and a plurality of reaction vessels positioned within the plurality of reaction vessel holders. The common process subsystem module is configured to position one or more reaction vessels containing aliquots of the sample for analysis by the clinical chemistry analyzer module, the immunochemistry analyzer module or both analyzer modules.

In a fourth aspect, method of performing both clinical chemistry assay and immunoassay tests on one or more samples with an automated instrument is disclosed. The method includes several steps, the first of which is configuring an instrument with an architecture of the system according to the third aspect. Additional steps of the method include providing the one or more samples to the instrument; providing one or more reagents for performing the clinical chemical assay tests to the instrument, wherein results of said tests are determined by UV-VIS spectrophotometry; providing one or more reagents for performing the immunoassay tests to the instrument, wherein results of said tests are determined by multiplex TRACE FRET analysis; and initiating an instrument program sequence.

### BRIEF DESCRIPTION OF THE FIGURES

FIG. 1 is a schematic diagram illustrating an embodiment of a common process path system and relative resource locations for a supporting system infrastructure.

FIG. 2 is a schematic diagram illustrating a variation of the embodiment of FIG. 1 that is configured for using disposable reaction vessels.

FIG. 3 is of an exemplary embodiment of a system and a processing path resource locations for achieving both immunoassay and clinical chemistry assay processing protocols.

FIG. 4 is a block diagram illustrating a multiplexed immunoassay module reader timing for use with a moving clinical chemistry process path.

FIG. 5 is a spectroscopic plot of reader strand stability for a given position window for measuring emission wavelength output for a reaction vessel as a function of time.

FIG. 6 is a block diagram illustrating an exemplary embodiment of a multiplexed immunoassay analyzer module to be used with the moving clinical chemistry process path.

### DETAILED DESCRIPTION

In the following detailed description, reference is made to the accompanying figures, which form a part hereof. In the figures, similar symbols typically identify similar components, unless context dictates otherwise. Insofar as possible, like parts and modules have the same reference numeral in the figures. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

As used herein, the expression “aliquot” is a portion of a sample that is used for testing. Aliquots of samples are sometimes created when multiple tests are ordered on a single sample, and the tests are performed on different instruments or in different areas of the testing department. Aliquots are prepared by transferring a portion of the sample into one or more additional tubes or vessels.

As used herein, the term “antigen” means a substance that can be bound by one or more antibodies. Examples of antigen include peptide, polypeptide, protein, nucleic acid (for example, DNA, RNA, PNA), among others, regardless of their form (for example, synthetic, recombinant or natural) and source (for example, isolated, partially purified, lysate, intact cells or biological fluids). In certain immunoassays, antigen can include a protein that is an antibody.

As used herein, the expression “control architecture” means a computer-implemented software program that is designed to control the operations of various modules and subsystems in a given system, including the electrical and mechanical operations required for accomplishing those operations and related functions.

As used herein, the expression “clinical chemistry analyzer” means an automated analyzer for determining the presence and/or concentration of a substance in a sample by means of a technique employing at least one chemical reaction. The chemical reaction can be an immunochemical reaction.

As used herein, the expression “immunoassay analyzer” means an automated analyzer for determining the presence and/or concentration of a substance in a sample by means of an immunoassay technique (that is, a technique employing antibodies to search for antigens or a technique employing antigens to search for antibodies). There are three types of immunoassays: a direct sandwich assay (that is, an assay that detects an antibody-antigen-antibody complex), a competitive assay, or an antibody detection assay. These types of immunoassays are well known to those having ordinary skill in the art.

As used herein, the term “module” means a self-contained unit of a system that performs a specific task or class of tasks for supporting the major functions of the system. For example, a system of clinical analyzers can include, but is not limited to, some of the following modules: sample dispensing module, immunoassay analyzer, clinical chemistry analyzer, a mixing station and a washing station. A given module of the system is preferably designed to be used with other modules of the system that are related thereto.

As used herein, the expression “reaction vessel” means a container in which a biochemical, chemical or immunochemical reaction, or measurement thereof, is carried out. Typically, reaction vessels are cuvettes when used in analyzer instruments.

As used herein, the term “sample” means at least one substance having chemical, biochemical or biological properties, regardless of its form (for example, synthetic, recombinant or natural) and origin (for example, isolated, partially purified, lysate, intact cells or biological fluids). Samples typically subjected to both clinical chemistry assay and immunochemistry assay include mixtures of substances, such as that present in a biological fluid, for example, blood.

As used herein, the expression “user interface” means any structure that permits operators or others to enter information, such as instructions, descriptions, data or commands, into a system or a control architecture of a system and/or that permits operators or users to acquire information, such as output, data or other details, about the system and its performance.

Disclosed herein are instruments, systems and methods for accomplishing both clinical chemistry assays and immunoassays on a single integrated automated platform. The integrated instruments and systems are configured to use a common process path for performing and analyzing both clinical chemistry assays and immunoassays, whereby the operator can configure different types of assay tests in real time (that is, during continuous operation of the instrument), depending on the operator's sampling needs and analytical requirements. The common process path for both types of analytical assay tests enables the same mechanical structure, such as the use of the same types of reaction vessels, processing modules, sample and reagent dispensing subsystems; the same incubation platform; and the same control architecture and user interface. The resulting integrated instruments and systems offer flexibility on the fly and robust configurations not previously possible for automated analytical instruments for either clinical chemistry assay or immunoassay testing. Furthermore, the resultant systems are more compact, less expensive, and more reliable, based on the reduction of assay processing resources. Preferred embodiments of these instruments, systems and methods for their use to conduct both clinical chemical assay and immunoassay tests are described herein.

One preferred embodiment is depicted in FIG. 1, wherein system 1000 includes a plurality of modules, such as common process subsystem module 100, a sample dispensing module 200, one or more reagent modules 300, a mixing module 400, an immunoassay analyzer module 500, a clinical chemistry analyzer module 600, a washing station module 700 and an optional ion analyzer module 800. With the exception of the immunoassay analyzer module 500, which is especially described in greater detail elsewhere in this disclosure, the remaining modules will be briefly described herein.

In another preferred embodiment (FIG. 2), system 1000 is configured as depicted in FIG. 1, except that washing station module 700 is replaced washing station module 750 and a reaction vessel loader 900. Such an embodiment is especially useful where the operator desires to use disposable plastic reaction vessels.

Referring to FIG. 3, common process subsystem module 100 includes an assembly 110 having a plurality of reaction vessel holders 120. Reaction vessels 130 are individually positioned in each of reaction vessel holders 120. Generally, reaction vessel holders 120 will possess a geometrically compatible shape to stably maintain the reaction vessels 130 for appropriate processing and assay testing by the various modules of system 1000.

Reaction vessels 130 can be of any material and shape suitable for being comprehended during analysis by the immunoassay analyzer module 500 and the clinical chemistry analyzer module 600. Preferably, reaction vessels 130 are composed of an optically transparent material, such as quartz, plastic or borosilicate glass material. A preferred optically transparent material for reaction vessels 130 is borosilicate glass. Reaction vessels 130 composed of borosilicate glass are preferably, as they are both inexpensive and amenable to washing and reuse. Reaction vessels 130 have a preferred shape of being square and having a standard optical path (for example, 5 mm).

Referring to FIGS. 1-3, the structures and functions of modules 200, 300, 350, 700, 750, 800 and 900 are well known in the art of automated clinical chemistry assay and immunoassay analyzers. These modules are described to illustrate features of various embodiments of system 1000 and are not to be construed as limiting different variations and adaptations of modules having equivalent functionality for system 1000.

Referring to FIGS. 1-2, sample dispensing module 200 includes a sample dispensing pipettor 210. Module 200 includes an automated mechanism and control for aspirating an aliquot of a sample from a sample container (not shown) and distributing the aliquot to a reaction vessel 130 located in reaction vessel holder 120 of assembly 110 (for example, at position denoted “S” of FIG. 3). The sample dispensing pipettor 210 can be suitably configured to deliver a diluted aliquot of the sample to another reaction vessel 130 located in adjacent reaction vessel holder 120 of assembly 110 (for example, at position denoted “DS” of FIG. 3). Preferably, dispensing pipettor 210 is a theta-Z pipettor. Module 200 is configured to accommodate washing operations for sample dispensing pipettor 210 between samples to minimize contamination between aliquots delivered to different reaction vessels 130.

Sample dispensing module 200 can be configured to have sample dispensing pipettor 210 aspirate and dispense a plurality of undiluted or diluted aliquots from a plurality of samples into a plurality of reaction vessels 130. Such processes may be required for performing a plurality of clinical chemistry assays for specific substances or for performing a plurality of immunoassays for specific antigens that may be present in a given sample. Sample dispensing module 200 can be configured to have sample dispensing pipettor 210 aspirate and dispense a plurality of samples in like fashion. In instances in which a plurality of samples are being processed using various embodiments of system 1000, the plurality of samples are preferably positioned into a track system, carousel or the like to enable automated sample presentation to the dispensing module 200.

Referring to FIGS. 1-2, reagent modules 300 contain the reagents necessary for performing the specific clinical chemistry assay and immunoassay tests of system 1000. Typically, reagent modules 300 include an assembly 310 configured with a plurality of different reagent compartments 320. Reagent modules 300 can be configured to refill the reagent compartments 320 as the reagents are dispensed. Likewise, reagent modules 300 can be configured for temperature control to maintain, store, and dispense reagents at appropriate temperature. Assembly 310 can have any configuration well known in the art. As depicted in the embodiments of FIGS. 1-2, one such preferred assembly 310 has the form of carousel having reagent compartments 320 organized in concentric fashion.

Referring to FIGS. 1-3, reagent modules 300 further include one or more reagent dispensors 350 to dispense reagents from reagent compartments 320 to reaction vessels 130. Reagent dispensors 350 are each configured with at least one dispensing pipettor 360. Preferably, dispensing pipettor(s) 360 are theta-Z pipettors. The dispensing operations of reagent dispensors 350 preferably dispense reagents to reaction vessels 130 located in reaction vessel holders 120 at two positions within assembly 110 (designated as “R1” and “R2” in FIG. 3). To minimize contamination, module 300 and/or dispensor 350 is configured to accommodate washing operations for dispensing pipette 360 after its dispensing operation for different reagent compartments 320 and for different reaction vessels 130.

The pipettors 210 and 360 display rotational capabilities from 0 degrees to 360 degrees about their respective axes. Depending upon the relative locations of their operational span (that is, the locations of their aspiration and dispensing points), pipettors 210 and 360 preferably display rotation capabilities from about 90 degrees to about 270 degrees about their respective axes.

Referring to FIG. 3, mixing module 400 provides mixing operations for the reagents with aliquots of samples in reaction vessels 130. As a reaction vessel holder 120 fitted with reaction vessel 130 is positioned at designated locations near mixing module 400 (for example, positions “M1” and “M2” of FIG. 3), mixer assembly 410 positions one or more mixer paddles 420 over reaction vessel holder 120. At least one mixer paddle 420, preferably fitted with at least one ultrasonic piezoelectric vibrator (not shown), is lowered into reaction vessel 130 and effects mixing by ultrasonic vibration. Once the mixing process is completed, mixer paddle 420 is raised out of the reaction vessel 130, the mixing assembly 410 positions the mixer paddle 420 to a position within the mixing module 400 to effect rinsing of the mixer paddle 420 to remove contaminants acquired on mixer paddle 420 from the contents of reaction vessel 130. Preferably, mixing module 400 conducts at least two mixing operations for the contents of each given reaction vessel 130, wherein the two mixing operations are associated with mixing the sample of the reaction vessel 130 with one or more clinical chemistry assay reagents, one or more immunoassay reagents, or combinations thereof.

Following mixing of the reaction samples, reaction vessels 130 are positioned for measurements performed by immunoassay analyzer module 500. Module 500 performs multiplexed immunoassay analysis on a plurality of reaction vessels 130 during one movement position of assembly 110. Module 500 preferably includes a light source 510, a multiplex light generator 520, a multiplex light reader 530 and a detector system 540. Preferably, module 500 has the capability of analyzing the reaction mixture of any given reaction vessel 130 at least ten times in a multiplex manner when reaction vessel holder 120 is positioned for analysis by module 500 (for example, positions denoted as “TR1” through “TR10” of FIG. 3).

The immunoassay analyzer module 500 is suitable for measuring immunoassays having homogeneous solution, antibody-antigen-antibody “sandwich” assay formats that enable detection of antigen-antibody complex formation by Förster Resonance Energy Transfer analysis (FRET analysis). In this approach, an excited state donor chromophore can transfer energy to an acceptor chromophore through non-radiative dipole-dipole coupling. Upon relaxing from its excited state, the acceptor chromophore releases this energy as a longer wavelength emission than the excitation wavelength. The efficiency of this energy transfer is inversely proportional to the sixth power of the distance between donor and acceptor making FRET extremely sensitive to small distances. Such measurements are used to determine if two fluorophores are within a certain distance of each other. Accordingly, two labeled antibodies specific for a given antigen are labeled individually with either a donor chromophore or an acceptor fluorophore. In the absence of the antigen, the two labeled antibodies are not in proximity to permit efficient energy transfer between donor and acceptor chromophore labels. In the presence of antigen to which both antibodies can bind simultaneously, the two labeled antibodies are preferably in proximity suitable for efficient energy transfer between the donor and acceptor chromophore labels.

Upon illumination of the contents of reaction vessel 130 with an excitation wavelength of light from multiplex light generator 520, the donor chromophore attached to one antibody reaches its excited state and subsequently transfers its energy to the proximal acceptor chromophore attached to the other antibody in the sandwiched complex. As the acceptor chromophore decays from its excited state, it releases light emission at a given wavelength that multiplex light reader 530 detects. As will be described in greater detail below, the reaction mixture of each reaction vessel 130 is read multiple times (for example, ten separate times), in a multiplex format, as individual reaction vessels 130 transit by immunoassay analyzer module 500.

Now referring to FIG. 4, additional operational details of a preferred immunoassay analyzer module 500 are described. As mentioned previously, measurements of a plurality of reaction vessels 130 are performed in a multiplex manner. To achieve reliable measurements, the module 500 performs repeated FRET analysis assays for the reaction mixture of each reaction vessel 130 as it transitions through multiple locations (termed “position windows”) using multiple fiber optic strands and an optical multiplexer (520/530) to provide excitation wavelength generation and emission wavelength detection from the reaction vessels 130 centered at each position window. For a first position window (for example, window position TR1), a first pair of optic strands that includes a first fiber optic strand addressing (that is, positioned for optical communication with) the first position window for generating the excitation wavelength to the reaction mixture of a reaction vessel 130 (“generator fiber optic strand” or “generator strand,” denoted as Ng, where N is a numeral; for example, 1g) and a second fiber optic strand addressing (that is, positioned for optical communication with) the first position window to detect wavelength light emissions from the reaction mixture of reaction vessel 130 (“read fiber optic strand” or “read strand,” denoted as Nr, where N is a numeral; for example, 1r). As reaction vessel 130 changes to a second position window (for example, window position TR2), a second pair of fiber optic strands (for example, generator strand 2g and read strand 2r) addresses the second position window to generate excitation wavelength and detect emission wavelengths from the reaction mixture of the reaction vessel 130. In one preferred embodiment, each reaction vessel 130 passes through a plurality of window positions, such as ten position windows (for example, TR1, TR2, TR2, . . . TR10), wherein each position window has a unique pair of generator and read fiber optic strands (for example, 1g and 1r; 2g and 2r; 3g and 3r; . . . , 10g and 10r) addressing that position window for generating the excitation wavelength light to the reaction mixtures of reaction vessel 130 and for detecting emission wavelength light from the reaction mixtures of the reaction vessel 130, respectively.

Because a different reaction vessel 130 will occupy the same position as the previous reaction vessel 130 in module 500 after a time period, all multiplexed reads for a single reaction vessel 130 must be accomplished before the next reaction vessel 130 is scanned. Only about 6.7 msec in the center of the moving reaction vessel 130 is considered the stable read region by multiplex reader 520 (see, for example, FIG. 5). For this reason, where ten position windows are individually read by separate fiber optic strands over the course of 24.25 msec, timing of each subsequent read fiber optic strand is preferably offset by about 2 msec from the preceding read fiber optic strand. Thus, for example, as a particular reaction vessel 130 passes through position windows TR1, TR2, TR3, . . . TR10, each respective generator strand 1g, 2g, 3g, . . . 10g and corresponding read strand 1r, 2r, 3r, . . . 10r addresses their respective position windows in optical operational terms by offset timing of 0 msec, −2 msec, −4 msec, . . . −18 msec, respectively. The multiplex generator 520 and the multiplex reader 530 switches among ten optical channels every 2 msec (termed “offset” or “multiplex time interval”), wherein only a single position channel is analyzed using a single pair of generator and read strands during a given multiplex time interval. Accordingly, each reactive vessel 130 is subjected to a total read time of about 20 msec as reaction vessel 130 transits through ten position windows having a multiplex time interval of about 2 msec.

Suitable chromophore “donor”-“acceptor” pairs that enable efficient FRET signal detection are well known in the art. Such labels can be readily incorporated into antibodies using standard coupling chemistries well understood in the art. Furthermore, adaptation of suitable chromophore label pairs having FRET signal capabilities can be devised that are spectrally and/or chemically compatible with the chromophores used in the clinical chemistry assays, thereby minimize or altogether eliminate signal cross-talk between assay reader platforms.

A preferred set of a suitable chromophore “donor”-“acceptor” pairs that enable efficient FRET signal in immunoassays is europium cryptate (donor) and XL665 (acceptor), such as those chromophores are used in time-resolved amplified cryptate emission (TRACE) assays. The europium cryptate chromophore is excited by 337 nm wavelength light, while the XL665 chromophore emits 665 nm wavelength light upon energy transfer from europium cryptate (excited state). A secondary measurement of emission at 620 nm is typically performed to provide a signal correction for optical properties of the medium transmission.

Preferred features of a preferred embodiment of immunoassay analyzer module 500 is illustrated in FIG. 6. Light source 510 includes laser assembly 512, plasma discharge cartridge 514, and optical laser to fiber 516, wherein the optical laser line filter 518 provides excitation wavelengths of the desired wavelength. Various light sources are available for generating the selected excitation wavelength light (for example, 337 nm for europium cryptate excitation) and are not limited to the laser and line filter shown.

Multiplex light generator 520 provides multiplex pulse generator capability preferably over ten channels, wherein excitation wavelengths delivered via fiber optic cable 502 from light source 510 can be distributed to individual generator strands 1g, 2g, 3g, . . . 10g addressing ten individual position windows TR1, TR2, TR3, . . . TR10, respectively. Utilization of a given generator strand that is associated with a given position window is offset in time (delayed) by about 2 msec from the preceding generator strand associated with the adjacent position window to enable the preceding read strand sufficient time to detect the emission wavelength from the preceding position window.

Multiplex light reader 530 detects the emission wavelength light from the respective read fiber optic strand that is associated with a given position window, as previously explained above and in FIG. 5. Like the multiplex light generator 520, multiplex reader 530 provides multiplex detection capability preferably over ten channels, wherein emission wavelengths can be detected from individual read strands 1r, 2r, 3r, . . . 10r addressing ten individual position windows TR1, TR2, TR3, . . . TR10, respectively. Utilization of a given read strand that is associated with a given position window is offset in time (delayed) by about 2 msec from the preceding read strand associated with the adjacent position window to enable the preceding read strand sufficient time to detect the emission wavelength from the preceding position window. Spectral information from each of the reader strands of multiplex reader 530 is transmitted via fiber optic cable 504 to detector 540.

The multiplex time interval for utilization of the fiber optic strands of multiplex generator 520 and multiplex reader 530 can be controlled by software located in module 500 or controlled elsewhere by software associated by system 1000, such as that associated with the control architecture.

Detector 540 provides for detecting the spectral properties of the emission from reaction vessel 130 obtained from multiplex reader 530. Detector 540 is fitted with dichroic visible mirror 541, photodiode board 542, diffusing filter 543, neutral density filter 544 and at least one detection channel 545. Detection channel 545 is configured with a suitable line filter 546 and a photomultiplier tube 557. Where one than one wavelength is being detected, such as in the case for XL665 that requires detection at two wavelengths (that is, 665 nm and 620 nm), two detection channels 545 are used.

For immunoassays that utilize TRACE, which uses europium cryptate and XL665 as donor and acceptor labels, respectively, various detection devices are available for 620 nm and 665 nm light and are not limited to the line filters and photomultiplier tubes shown for one or more detection channels 545. Immunoassays based upon FRET analysis using other chromophore donor and acceptor pairs as FRET labels may have excitation and emission wavelengths that differ from the pair consisting of europium cryptate and XL665. For those immunoassays, the selection of the appropriate line filters and photomultiplier tubes for one or more detection channels 545 will be contingent upon the spectral properties of those FRET labels.

Referring again to FIGS. 1-3, reaction mixtures of reaction vessels 130 are positioned for measurements with clinical chemistry analyzer module 600. Module 600 can have a standard configuration for measuring any particular spectroscopic property of the clinical chemistry assay test as needed, such as, for example, UV-VIS absorbance properties of a chemical assay reaction product. Absorbance measurements by module 600 is typically achieved by illuminating the contents of a reaction vessel with broad-spectrum light using source lamp 610. A reader 620 is used to detect the absorbance of specific wavelengths of light from the sample by resolving the light into a plurality of wavelengths (for example, 16 wavelengths) with a diffraction grating, prism or the like and detecting absorbance at those wavelengths with a photomultiplier tube, photodiode or the like.

The contents of each reaction vessel 130 are subsequently removed following assay testing through operation of washing station module 700. Referring to FIGS. 1 and 3, module 700 performs a number of functions related to the washing of reaction vessels 130 (for example, borosilicate glass vessels) for their subsequent reuse in system 1000. These process steps preferably include: a high-concentration waste aspiration; an alkaline detergent wash; an acid detergent wash; one or more deionized water wash(es); a blank water measurement; a water aspiration step; and a drying step. Module 700 can be configured with dual-head single function nozzles for performing separate wash fluid dispensing and aspirations for each of the identified process steps (see FIGS. 1 and 3) or with single-head combination wash fluid/aspiration nozzles for performing each identified process step (not shown).

Referring to FIG. 2, washing station module 750 and an reaction vessel loader 900 are used in a preferred embodiment of system 1000 that uses disposable reaction vessels 130 (for example, plastic reaction vessels). Module 750 need not contain the process steps of module 700 since the reaction vessels 130 of this embodiment are typically disposed following use in common process subsystem module 100. Such reaction vessels 130 will be subjected to a high-concentration waste aspiration step using module 750 and removed from reaction vessel holder 120 of assembly 100 using reaction vessel loader 900. Loader 900 then positions a new reaction vessel 130 into vacant reaction vessel holder 120. The new reaction vessel 130 is then positioned in module 750 for receiving processing steps to ensure cleanliness (for example, a deionized water wash step; a blank water measurement; a water aspiration step; and a drying step).

Referring to FIGS. 1-3, measurement of select ions in reaction vessel 130 (for example, potassium, sodium, chloride, etc.) is accomplished with optional ion analyzer module 800. Module 800 is preferably fitted with integrated chip technology (ITC) to detect tests with an ion selective electrode (not shown) and sampling can be conducted along the common process path, such as at the ICT aspirate position adjacent to module 800 (see location denoted as “ICT” in FIG. 3).

As illustrated in FIGS. 1 and 3, assembly 110 is preferably configured as a carousel to have reaction vessel holders 120 arranged sequentially along the circumference of assembly 110. The various modules 200, 300, 400, 500, 600, 700 and 800 are preferably distributed around common process subsystem module 100 to permit multiple processing tasks to be performed simultaneously for different reaction vessels 130 located in reaction vessel holders 120 of assembly 110. Because at least seven discrete processes can be effected with any given reaction vessel 130 with the identified modules of system 1000, assembly 110 preferably has at least seven reaction vessel holders 120 fitted with a corresponding number of reaction vessels 130. More preferably, however, and depending upon the overall size of process path subsystem module 100, assembly 110 is configured to accommodate any practical number of reaction vessels 130, including 25, 50, 75, and 100 reaction vessels 130. A highly preferred assembly 110 is configured to accommodate 99 reaction vessel holders 120 to accommodate a like number of reaction vessels 130.

During operation of common process subsystem module 100, assembly 110 transitions from between processing stations in lock-step fashion preferably by completing more than one complete rotation. For example, sampling dispensing module 200 may be preferably located about 25 reaction vessel holder 120 positions from reagent module dispensor 350 that dispenses a first reagent (see, for example, R1 in FIG. 3). For an assembly 110 that contains 99 reaction vessel holders 120, assembly 110 transitions 124 positions during an index interval to move a reaction holder 120 position containing a reaction vessel 130 from sampling module 200 to reagent module 300 so that the next processing step can occur for that given reaction vessel.

A particularly advantageous aspect to the operation of common process subsystem module 100 comes from the fact that immunoassay analyzer module 500 and clinical chemistry analyzer module 600 are preferably configured to read any reaction vessel that transitions within the readers' respective read position windows. Thus, the contents of every reaction vessel 130 in assembly 110 can be read on the fly by both modules 500 and 600 during every index interval that assembly 110 transitions between processing stations.

Some reaction vessels 130 located in common process subsystem module 100 may not contain a competent reaction mixture for assay testing for a variety of process reasons (for example, lack of a reagent addition, lack of a mixing operation, insufficient reaction incubation time, cleaning operations, etc.). Reader scan data acquired by modules 500 and 600 can be analyzed by appropriately configured analysis software of the control architecture to retain only scan data for reaction vessels 130 that contain competent reaction mixtures and discard the rest of the acquired reader data.

The organization and location of the various modules are flexible in various embodiments of system 1000, being only dependent upon the direction of movement of assembly 110 with respect to the various modules (for example, the locations of the sample dispensing module 200 and the washing station module 700 can be typically be adjacent to one another in common process subsystem module 100). In the embodiments depicted in both FIGS. 1-2, and as further elaborated in FIG. 3, the direction of common process subsystem module 100 is clockwise, where the process path begins with introduction of an aliquot of a sample into reaction vessel 130 using sample dispensing module 200. In terms of the process path and timing, reaction vessels typically encounter certain modules before other modules, as process logic dictates.

Preferred embodiments of system 1000 represent integrated systems that are configured to use common robotic resources to process both immunoassays and clinical chemistry assays on a single process path. Since immunoassay tests based upon FRET analysis are homogeneous, they can be processed in a similar fashion to clinical chemistry assay tests. In one embodiment, a time to results of an analyzing process is typically less than or equal to about ten minutes for tests for both clinical chemistry assays and immunoassays. Thus, process path subsystem module 100 of the system 1000 is configured size-wise to process both clinical chemistry assay tests and immunoassay tests within one complete rotation of assembly 110.

The preferred physical configuration of the system 1000 enables an assay processing and testing to be performed randomly and to provide continuous access. The configuration of system 1000 enables an index time (that is, a period between carousel position movements for assembly 110) to be about nine seconds for assay tests. Thus, system 1000 that includes an assembly 110 with a 99 reaction vessel holders 120 can process as many as 400 tests per hour when assembly 110 is programmed with an index time of 9 seconds, regardless of the assay test format (clinical chemistry assay only, immunoassays only, or a combination of both clinical chemistry assays and immunoassays). Furthermore, the user can alter the types and numbers of tests performed and samples analyzed on the fly while the instrument is performing automated operations on aliquots of samples by inputting different operational instructions at the user interface for implementation by the control architecture.

The system is preferably established in an environment wherein the operator or a laboratory information system may download test orders to the system for samples that will eventually be presented to the system for testing. The operator will load the required consumables on to the system. The operator or laboratory information system will present the required samples to the system. In a laboratory information system installation, the sample loading and reagent loading would simply be replaced by a laboratory information system track and local queue(s). The system is configured to perform the standard operations of the process modules, including automatically dispense sample(s) and reagent(s), mix to initiate incubation time periods, add subsequent reagent(s), detection and reaction vessel clean-up (wash and reuse or disposal). The system will determine and report the analyte and/or antigen in a sample, according to the downloaded test order for that sample. The operator or laboratory information system will then remove the samples from the system. The operator or laboratory information system will subsequently review and/or release test results to the origin of the test order.

Example 1 illustrates a detailed timing and functionality of the clinical chemistry assay and immunoassay tests processing path system for an instrument set up to analyze 99 reaction vessels. In general terms, a clinical chemistry assay test or immunoassay test involves one trip around the processing path, for a time-to-results of 10 minutes. Some assays may be completed in as little as 5 minutes, depending on the assay specific protocol. Further, some assays may require additional time and more than one trip around the processing path, for a time to results of 20 minutes. Thus, the overall throughput on the integrated system will depend upon the specific assay tests performed.

The following non-limiting example illustrates the operations of the various sampling systems described herein. The following example generally employs modules and subsystems of the type shown in FIGS. 1 and 3.

### Example 1

### Operation of an Exemplary Integrated Analyzer for Both Clinical Chemistry Assay Tests and Immunoassay Tests

Table 1 illustrates a timing table the programmed operational steps for process path carousel that includes 99 reaction vessel holders and a like number of reaction vessels. For illustration purposes (and equivalency to typical Architect® protocols), this process path is indexed every nine seconds to provide a rotating carousel moving through 124 positions every nine seconds to exposure a new reaction vessel at each processing module function, such as sample addition, reagent addition, mixing, washing, etc. When a sample tube is positioned for testing, sample is aspirated (and dispensed) and either one immunoassay test or one clinical chemistry assay test is initiated every nine seconds until no more tests are required for that sample. Subsequently, assay specific reagent(s) are aspirated from the reagent carousel and dispensed into the reaction vessels. Mixing is accomplished invasively from above with stirring devices, and washed between mixing operations to prevent carryover between sets of reaction vessels. The assay processing protocols are performed using the carousel process path described in FIGS. 1 and 3; the sample and reagent(s) are incubated and read every nine seconds for five minutes. The readers of the immunoassay analyzer modules and the clinical chemistry analyzer modules of a carousel process path provide multiple read points through the operation of a mechanical cycle, wherein every reaction vessel in the carousel passes the readers every nine seconds. After five minutes, a second reagent is subsequently added (for most assays), and the contents of reaction vessels are remixed. The contents of the reaction vessels are incubated and read every nine seconds for another 5 minutes. Time-to-results is 5-10 minutes, depending on the assay. After the completion of the assay, reaction vessels are washed several times and dried, so that they can be reused.

With reference to Table 1, a reaction vessel holder advances to the next processing station by the carousel moving about 1.25 rotation cycles during each index interval time. Only a limited number of reaction vessels are engaged in processing activities during any given index time interval (for example, cuvette ##1, 75, 50, 99, 22, 91, 66, 33, 32, 31, 30 29, 28 27, and 26 of Table 1). Yet all reaction vessels that contain a mixed reaction mixture (that is, an aliquot of a sample and at least one reagent for an immunoassay or clinical chemistry assay) are read by the multiplex immunoassay analyzer module and chemical chemistry analyzer module during each carousel movement cycle (for example, cuvettes at positions 4-70 of Table 1).

TABLE 1
Timing Table For Programmed Operations

| | | | Read | Read |
|---|---|---|---|---|
| Position | Cuvette # | Operation | point | timing |
| 1 | 1 | Sample dispensing | — | — |
| 2 | 75 | First reagent dispensing | — | — |
| 3 | 50 | First stirring | 1 | 0 |
| 4 | 25 | | 2 | 10.79 |
| 5 | 99 | Diluted sample aspiration | 3 | 19.19 |
| 6 | 74 | | 4 | 27.58 |
| 7 | 49 | | 5 | 38.38 |
| 8 | 24 | | 6 | 46.77 |
| 9 | 98 | | 7 | 55.16 |
| 10 | 73 | | 8 | 63.56 |
| 11 | 48 | | 9 | 74.35 |
| 12 | 23 | | 10 | 82.75 |
| 13 | 97 | | 11 | 91.14 |
| 14 | 72 | | 12 | 99.53 |
| 15 | 47 | | 13 | 110.33 |
| 16 | 22 | ICT aspiration | 14 | 118.72 |
| 17 | 96 | | 15 | 127.12 |
| 18 | 71 | | 16 | 135.51 |
| 19 | 46 | | 17 | 146.3 |
| 20 | 21 | | 18 | 154.7 |
| 21 | 95 | | 19 | 163.09 |
| 22 | 70 | | 20 | 171.49 |
| 23 | 45 | | 21 | 182.28 |
| 24 | 20 | | 22 | 190.67 |
| 25 | 94 | | 23 | 199.07 |
| 26 | 69 | | 24 | 207.46 |
| 27 | 44 | | 25 | 218.26 |
| 28 | 19 | | 26 | 226.65 |
| 29 | 93 | | 27 | 235.04 |
| 30 | 68 | | 28 | 243.44 |
| 31 | 43 | | 29 | 254.23 |
| 32 | 18 | | 30 | 262.62 |
| 33 | 92 | | 31 | 271.02 |
| 34 | 67 | | 32 | 279.41 |
| 35 | 42 | | 33 | 290.21 |
| 36 | 17 | | 34 | 298.6 |
| 37 | 91 | Second reagent dispensing | 35 | 306.99 |
| 38 | 66 | Second stirring | 36 | 315.39 |
| 39 | 41 | | 37 | 326.18 |
| 40 | 16 | | 38 | 334.58 |
| 41 | 90 | | 39 | 342.97 |
| 42 | 65 | | 40 | 351.36 |
| 43 | 40 | | 41 | 362.16 |
| 44 | 15 | | 42 | 370.55 |
| 45 | 89 | | 43 | 378.95 |
| 46 | 64 | | 44 | 387.34 |
| 47 | 39 | | 45 | 398.13 |
| 48 | 14 | | 46 | 406.53 |
| 49 | 88 | | 47 | 414.92 |
| 50 | 63 | | 48 | 423.32 |
| 51 | 38 | | 49 | 434.11 |
| 52 | 13 | | 50 | 442.5 |
| 53 | 87 | | 51 | 450.9 |
| 54 | 62 | | 52 | 459.29 |
| 55 | 37 | | 53 | 470.09 |
| 56 | 12 | | 54 | 478.48 |
| 57 | 86 | | 55 | 486.87 |
| 58 | 61 | | 56 | 495.27 |
| 59 | 36 | | 57 | 506.06 |
| 60 | 11 | | 58 | 514.46 |
| 61 | 85 | | 59 | 522.85 |
| 62 | 60 | | 60 | 531.24 |
| 63 | 35 | | 61 | 542.04 |
| 64 | 10 | | 62 | 550.43 |
| 65 | 84 | | 63 | 558.82 |
| 66 | 59 | | 64 | 567.22 |
| 67 | 34 | | 65 | 578.01 |
| 68 | 9 | | 66 | 586.41 |
| 69 | 83 | | 67 | 594.8 |
| 70 | 58 | | 68 | 603.2 |
| 71 | 33 | High-concentration waste | — | |
| | | aspiration | | |
| 72 | 8 | | — | |
| 73 | 82 | | — | |
| 74 | 57 | | — | |
| 75 | 32 | Washing with alkaline detergent | — | |
| 76 | 7 | | — | |
| 77 | 81 | | — | |
| 78 | 56 | | — | |
| 79 | 31 | Washing with acid detergent | — | |
| 80 | 6 | | — | |
| 81 | 80 | | — | |
| 82 | 55 | | — | |
| 83 | 30 | Washing with deionized water | — | |
| 84 | 5 | | — | |
| 85 | 79 | | — | |
| 86 | 54 | | — | |
| 87 | 29 | Washing with deionized water | — | |
| 88 | 4 | | — | |
| 89 | 78 | | — | |
| 90 | 53 | | — | |
| 91 | 28 | Water blank measurement | — | |
| 92 | 3 | | — | |
| 93 | 77 | | — | |
| 94 | 52 | | — | |
| 95 | 27 | Water aspiration | — | |
| 96 | 2 | | — | |
| 97 | 76 | | — | |
| 98 | 51 | | — | |
| 99 | 26 | Drying | — | |

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

1. An instrument for performing automated integrated analysis of both clinical chemistry assay and immunoassay tests on a sample, said system comprising:
(a) a common process subsystem module;
(b) a clinical chemistry analyzer module;
(c) an immunoassay analyzer module; and
(d) a plurality of additional modules,
wherein the common process subsystem module is configured to position one or more reaction vessels containing aliquots of the sample for analysis by the clinical chemistry analyzer module, the immunochemistry analyzer module or both analyzer modules.

2. The instrument of claim 1, wherein the clinical chemistry analyzer module comprises a UV-VIS absorbance detector.

3. The instrument of claim 1, wherein the immunoassay analyzer module comprises:
(a) a light source;
(b) a multiplex light generator;
(c) a multiplex light reader; and
(d) a detector system.

4. The instrument of claim 3, wherein the immunoassay analyzer module is configured for FRET analysis.

5. The instrument of claim 4, wherein immunoassay analyzer is configured to perform a multiplex FRET analysis on a plurality of reaction vessels containing an aliquot of the sample and immunoassay reagents.

6. The instrument of claim 5, wherein the multiplex FRET analysis comprises TRACE FRET analysis.

7. The instrument of claim 4, wherein the immunoassay analyzer module is configured to receive a plurality of reaction vessels in a plurality of position windows for multiplex analysis, wherein each position window is addressed by a generator strand leading from the multiplex light generator and by a read strand leading to the multiplex light reader, wherein timing of channel selection among the plurality window positions is selected to permit one member of the plurality of reaction vessels centered in one of a plurality of position window to be analyzed for a multiplex time interval.

8. The instrument of claim 7, wherein timing of the channel selection provides for a multiplex time interval of about 2 milliseconds.

9. The instrument of claim 7, wherein the plurality of position windows comprise ten position windows.

10. The instrument of claim 7, wherein the detector includes a first detection channel and a second detection channel.

11. The instrument of claim 10, wherein the first detection channel is configured to detect 665 nm wavelength light and the second detection channel is configured to detect 620 nm wavelength light.

12. The instrument of claim 1, wherein the common process subsystem module comprises:
(a) an assembly comprising a carousel having a plurality of reaction vessel holders; and
(b) a plurality of reaction vessels,
wherein the plurality of reaction vessels are positioned within the plurality of reaction vessel holders.

13. The instrument of claim 12, wherein the plurality of additional modules comprise at least two members selected from the group consisting of a sample dispensing module, one or more reagent modules, a mixing module, a washing station module, a reaction vessel loader and an ion analyzer module.

14. The instrument of claim 12, wherein the plurality of additional modules comprise a sample dispensing module, one or more reagent modules, a mixing module and a washing station module.

15. The instrument of claim 12, wherein the plurality of reaction vessels comprise reaction vessels having an optical transparent material selected from the group consisting of quartz, borosilicate glass and plastic.

16. The instrument of claim 12, wherein the plurality of reaction vessels comprise borosilicate glass reaction vessels.

17. The instrument of claim 14, wherein the sample dispensing module includes a sample dispensing pipettor.

18. The instrument of claim 14, wherein the one or more reagent modules each comprises:
(a) a plurality of reagent compartments; and
(b) a reagent dispenser configured with a dispensing pipettor.

19. The instrument of claim 14, wherein the mixing module comprises at least one mixer paddle.

20. The instrument of claim 14, wherein the washing module comprises a plurality of nozzles.

21-51. (canceled)
